(19) United States
(12) Patent Application Publication
(10) Pub. No.: US 2006/0289538 A1
(43) Pub. Date: Dec. 28, 2006

(54) Sleeve-suspended and color-coded safety valve for a pressure cooker and a pressure cooker using the same

(76) Inventor: Tom Hiroshi Hasegawa, Gardena, CA (US)

Correspondence Address: KODA & ANDROLIA, 2029 CENTURY PARK EAST, SUITE 1140, LOS ANGELES, CA, 90067, US

(21) Appl. No.: 11/166,551

(22) Filed: Jun. 23, 2005

(51) Int. Cl. B65D 51/16; G01N 31/22

(52) U.S. Cl. 220/203.29; 220/367.1; 116/200

(57) ABSTRACT

A safety valve for a pressure cooker including: a valve device having a valve cylinder casing that is in color denoting danger, a valve device suspending sleeve in which the valve device is provided so that the valve device is movable within the valve device suspending sleeve in the axial direction of the valve device, a band member provided on the upper portion of the valve cylinder casing of the valve device so that the band supports the valve device on the valve device suspending sleeve, the band member being in color denoting safety, and a nut engaged to the valve device suspending sleeve to secure the valve device suspending sleeve to the lid.

### BACKGROUND OF THE INVENTION

1. Field of the Invention

The present invention relates to a pressure cooker and more specifically, to a pressure cooker with a safety valve that is suspended to allow the control of the interior air pressure and is color-coded to indicate the existence of air pressure within the pressure cooker.

2. Prior Art

A pressure cooker is a cooking utensil (pot) that utilizes high-temperature and high-pressure steam to cook food inside the pot. The pot and its lid are designed to create an airtight space inside the pot. When the pot is heated, the air inside expands. The expanding air inside the pot is unable to escape, so the atmospheric pressure within the pot increases. As the atmospheric pressure increases, the boiling point of water also increases. Thus, a pressure cooker enables the water or moisture in the pot to become hotter than it would under normal atmospheric pressure.

With a conventional cooking pot, the water inside a pot turns into steam at around 100° C. (212° F.). The steam freely escapes the pot, leaving the atmospheric pressure within the pot close to normal and the temperature close to 100° C. Consequently, a large portion of the heating energy applied to the pot is wasted in warming the surrounding air.

In addition to creating a high-pressure environment within a pot, a pressure cooker also makes the water in the pot, in addition to the moisture within food, hotter than 100° C. and this impacts cooking in three ways. First, food cooks much faster in a high-pressure and high-temperature environment, and requires far less cooking or heating time. The cooking time is shortened to one-third or one-fourth of the time required for a conventional cooking pot. Second, the decreased cooking time and trapped steam result in greater energy efficiency. Pressure cooker generally requires only one-fourth to one-third of the energy of a conventional cooking pot. Third, high-temperature, high-pressure cooking significantly improves cooking in high altitudes and in cold climates.

Unfortunately, there is an omnipresent risk of explosion caused by too much pressure inside the pot. This risk is very real because a pressure cooker prohibits the free circulation of air between the interior and the exterior of the pot and cooks food under high-pressure and high-temperature conditions. Present pressure cooker manufacturers alleviate this risk in many ways, including: using sturdier materials to construct pots; utilizing a timer to control the length of heating time; installing a pressure gauge to monitor the atmospheric pressure inside; installing a pressure release valve; and installing a safety valve.

A safety valve is a device that is physically attached to a pressure cooker. Its function is to release the pressurized air in a pot when the atmospheric pressure within the pot exceeds a pre-set point. The safety valve is usually installed in the pressure cooker lid. The interior portion of the valve is shaped like a pipe and it has a spring-laden valve cylinder inside and an open end. The exterior portion of the valve is an extension of the interior pipe and it has an aperture in its wall. This aperture is kept closed by the valve cylinder. When the pressure of the air or steam pressing against the bottom of the valve cylinder becomes greater than the pressure that keeps the valve cylinder at a lowered position and the aperture closed, the cylinder valve rises past the aperture and the aperture opens and releases the inside air, which reduces the atmospheric pressure within the pressure cooker. The exterior portion of the safety valve is also equipped with a lever that enables users to lift the valve cylinder past the aperture, allowing to release the interior pressure manually.

While this type of safety device is widely used and is effective in coping with high-degree pressure buildups during heating, it does not address to the dangers associated with the other aspect of pressure cooking. This aspect is cooking that takes place continuously after heating is done. At this stage, food is being cooked by the heat retained in the surrounding air, the cooking pot and even in the food itself. This process is often very important to ensure even and thorough cooking, proper texture, complete immersion of seasonings and sometimes desired fluffiness. In fact, almost all recipes call for 10 to 30 minutes of this process before the food is taken out of the pressure cooker. When this process is over, users are instructed to release the interior pressure completely before they remove the lid of the pressure cooker. This is done by turning the manual release lever to the horizontal position to open the aperture of the safety valve. A hissing sound can be heard as the pressurized air is released outside of the pressure cooker, and the sound eventually stops as the interior pressure comes down close to normal atmospheric pressure. And it is now safe to remove the lid. Theoretically, there is no hidden danger in this action. But, in actuality, several things can go wrong: a user may simply forget to release the interior pressure by manually turning the release lever; the hissing sound may become inaudible as the pressure goes down especially in a busy, noisy kitchen; a user may inadvertently return the release lever to the upright position after an initial bursting release of the interior pressure, allowing the interior pressure to build up again to a dangerous level, and a user may mistakenly think that the cooker or the food inside is cool enough to handle rather casually once the interior pressure is released manually. In fact, these incidents happen quite often enough resulting in severe burns to the user's hands and arms caused by spewing steam and/or food contents or by very hot pressure cooker components. Conventional safety valves do very little to prevent these incidents. In fact, the only protection users may receive can be a simple warning in accompanying literature which says, “Before you remove the lid, make sure the interior air pressure is completely released and the cooker is cool enough to do so safely.”

### SUMMARY OF THE INVENTION

The two objectives of the present invention are to provide a safety valve and to provide a significantly safer pressure cooker with a safety valve which has a mechanism that allows it to release interior air pressure at a relatively low pressure range after the extremely high air pressure within the pressure cooker is released manually by opening the air aperture of the safety valve and by incorporating a color-coded safety/warning system in the safety valve that visually signals to users whether it is safe to remove the lid of the pressure cooker or not.

The objectives are accomplished by an innovative and unique safety valve specifically designed for a pressure cooker, which is suspended within a sleeve formed in the lid of a pressure cooker and is formed with two color bands on its pipe-shaped casing.

More specifically, a sleeve-like structure is installed in the lid of the pressure cooker and the safety valve is suspended within this sleeve allowing the safety valve to move vertically depending on the degree of air pressure within the pressure cooker. A color band is formed at the top portion of the pipe-shaped valve cylinder casing of the safety valve. This band has a certain thickness so that, when formed around the casing, it prevents the safety valve from falling through the sleeve. The valve cylinder casing is made with colored material, the color of which is different from that of the above-mentioned band, so that when the safety valve is in a lifted position, both colors become visible. Since the vertical movement of the safety valve is subject to the air pressure within the pressure cooker, the visible color(s) can be indicative of the state of the interior pressure. Thus, it provides an easy-to-recognize safety/warning system that signals to users whether it is safe to remove the lid of the pressure cooker.

### BRIEF DESCRIPTION OF THE DRAWINGS

FIG. 1 illustrates a safety valve with a colored valve cylinder casing according to the present invention;

FIG. 2 illustrates a colored band to be provided on the top portion of the colored valve cylinder casing in the present invention;

FIG. 3 is a side view of the safety valve suspending sleeve in the present invention;

FIG. 4 illustrates a washer which is installed on the upper surface of the casing lip in the present invention;

FIG. 5 illustrates a nut that fixes the safety valve suspending sleeve to the lid of a pressure cooker form the underside of the lid in the present invention;

FIG. 6 is a front view of the safety valve according to the present invention;

FIG. 7 is a side view of the safety valve according to the present invention;

FIG. 8 is a top view of the safety valve according to the present invention; and

FIG. 9 is a bottom view of the safety valve according to the present invention.

FIG. 10 is a front view of the safety valve according to the present invention when the safety valve is at its lowest position and only the top color band is visible;

FIG. 11 is a front view of the safety valve according to the present invention when the safety valve is at its highest position and both color band are visible with the safety valve aperture closed;

FIG. 12 is a front view of the safety valve according to the present invention when the safety valve is at its highest position and both color band are visible with the safety valve cylinder being lifted up and the safety valve aperture opened;

FIG. 13 shows how the safety valve of the present invention is inserted from the upper side of the lid of the pressure cooker and is secured by a nut in the present invention;

FIG. 14 shows the safety valve of the present invention fully assembled and secured to the lid of the pressure cooker in the present invention; and

FIG. 15 shows a pressure cooker installed with the safety valve of the present invention.

### DETAILED DESCRIPTION OF THE INVENTION

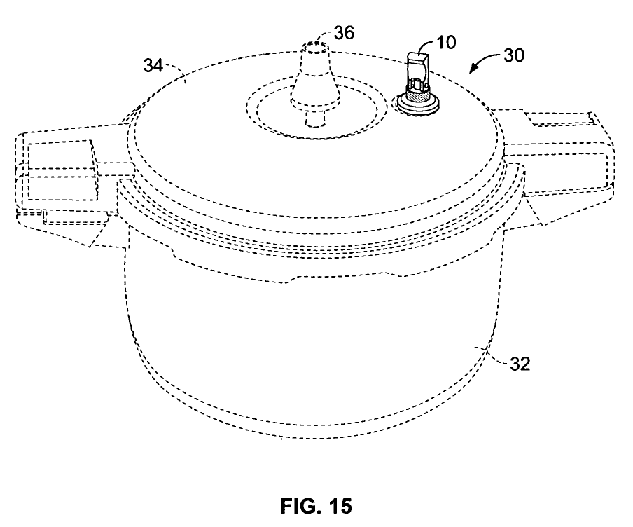

The sleeve-suspended and color-coded safety valve 10 of the present invention (See FIG. 15) is used in an ordinary pressure cooker 30 that includes a pot 32, a lid 34 that is fitted on and closes an opening of the pot 32, and a pressure regulator 36 that regulates the pressure (heated or hot air) inside the pot 32 during cooking. A conventional safety valve is often used also to prevent abnormal and hazardous pressure buildup and to enable manual release of interior pressure without opening the lid of the pressure cooker.

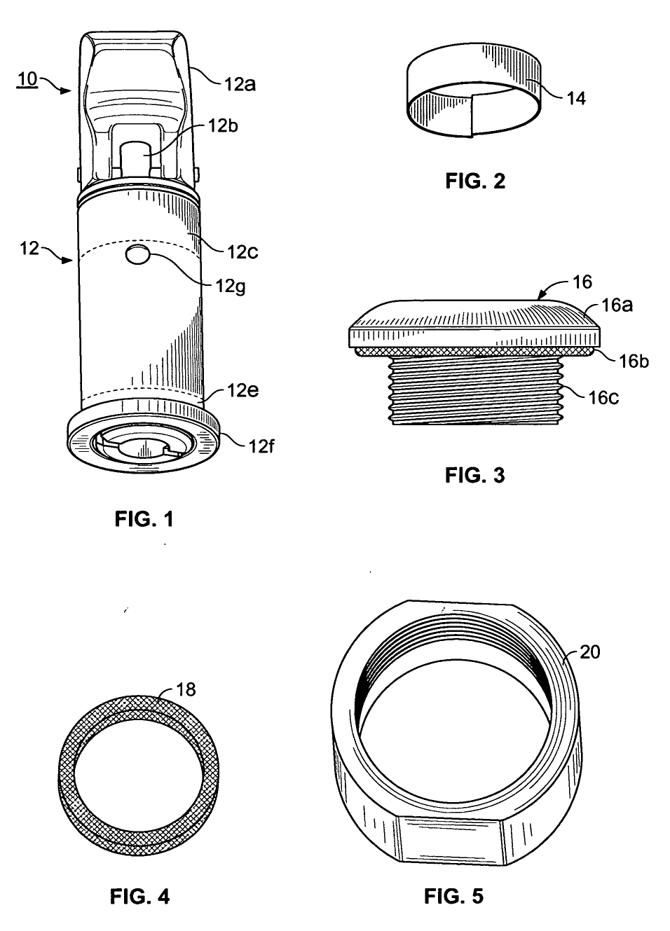

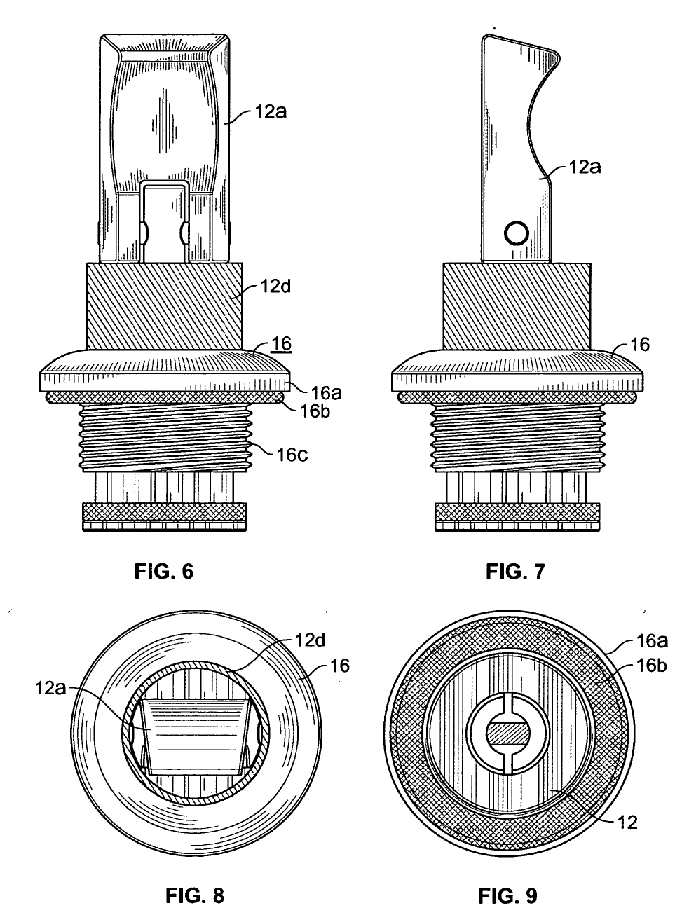

The sleeve-suspended and color-coded safety valve 10 of the present invention (see FIGS. 1 through 5) comprises a valve device 12, which is similar to conventional safety valve in basic construction and function, a color band member 14 which is provided on the valve device 12, a valve device suspending sleeve 16 which hold the valve device 12 therein, a washer 18 which is disposed on the lower end of the valve device 12 and a sleeve securing nut 20 which is engageable to the valve device suspending sleeve 16.

The valve device 12 which is typically made of metal is comprised of, as seen from FIG. 1, a manual release lever 12a, a valve cylinder 12b, an air way (not shown) formed inside the valve cylinder 12b, a valve cylinder casing 12d and an air aperture 12g formed in the valve cylinder casing 12d; and the safety valve 10 of the present invention incorporates the functions of the conventional safety valve in its basic component, which is hereafter referred as the valve device.

The valve device 12 is similar to a typical conventional safety valve except that the valve cylinder casing 12d is made of colored material or has a thin colored coating and that it has a lip 12f formed around its bottom or at a lower end of the valve cylinder casing 12d. The color of the valve cylinder casing 12d is preferably red or orange or one of the stimulating colors often used in signage for warning or cautioning.

The washer 18 is fitted onto the valve device 12, and it sits on the upper side 12e of the lip 12f. Its size and material are such so they secure tight fitting around the valve cylinder casing 12d and complete contact to the surface of the upper side of the lip 12f.

The valve device suspending sleeve 16 comprises a top ring 16a and a thread ring 16c. A sealing ring 16b can be disposed underneath the top ring 16a.

When the sleeve-suspended safety valve 10 is installed onto the lid 34 of the pressure cooker 30, the top ring 16a and the sealing ring 16b are located on the upper (exterior) side of the lid 34 and the threaded ring 16c extends to the lower (interior) side of the lid 34. The material of the sealing ring 16b is such material so that it makes airtight contact to the surface of the lid 34. The interior diameter of the valve device suspending sleeve 16 is formed to be slightly larger than that of the valve cylinder casing 12d so that it allows the valve cylinder casing 12d (or the valve device 12) to move smoothly up and down or move in the axial direction of the valve device within the valve device suspending sleeve 16. The difference in diameters, however, is to be small enough to induce “water seal” effect under certain conditions (air pressure, existence of water or moist air) where moisture is sucked up into the gap between the interior surface of the valve device suspending sleeve 16 and the exterior surface of the valve cylinder casing 12d and effectively seals the gap, obstructing the air flow through the gap. The valve device 12 is then inserted into the valve device suspending sleeve 16 from the threaded ring 16c side of the valve device suspending sleeve 16. The bottom of the threaded ring 16c of the valve device suspending sleeve 16 sits flatly on the upper side of the washer 18 of the valve device 12.

The color band 14, which is typically made of metal, is then securely provided (by, for instance, being clamped or press-fitted) on and around the top or upper portion 12c of the valve cylinder casing 12d. The color band 14 has a certain thickness so that the diameter of the banded section of the valve casing 12d becomes larger than the interior diameter of the valve device suspending sleeve 16, allowing the valve device 12 to be suspended by the valve device suspending sleeve 16. The color of the color band 14 is preferably green or any of the soothing colors that denotes safety.

Assembled sleeve-suspended and color-coded safety valve 10 is then installed onto the lid 34 of the pressure cooker 30 by applying the nut 20 onto the threaded ring 16c of the valve suspending sleeve from the under (interior) side of the lid 34 and tightening it firmly with the lid 30 between the valve device suspending sleeve 16 and the nut 20.

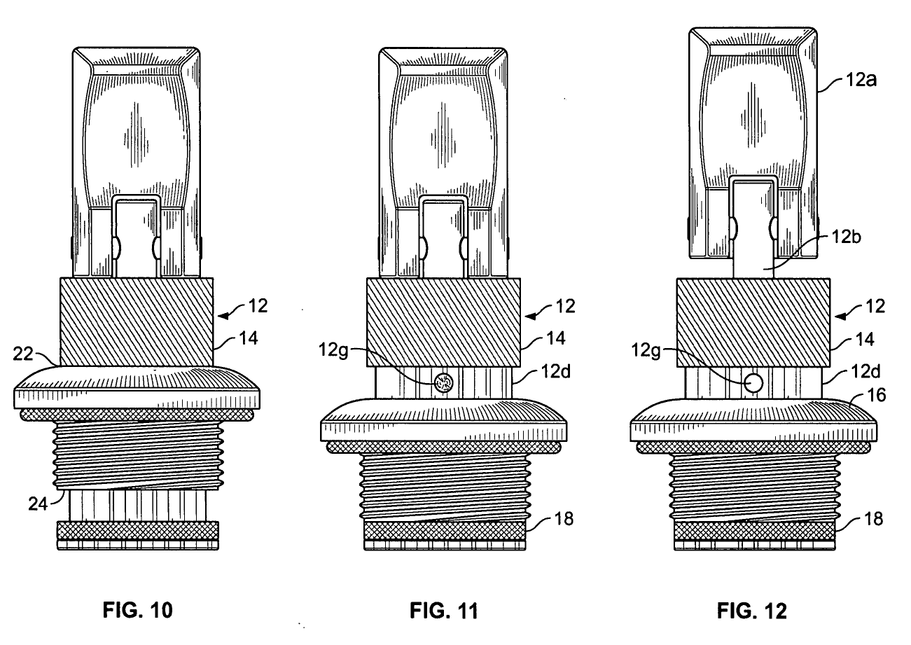

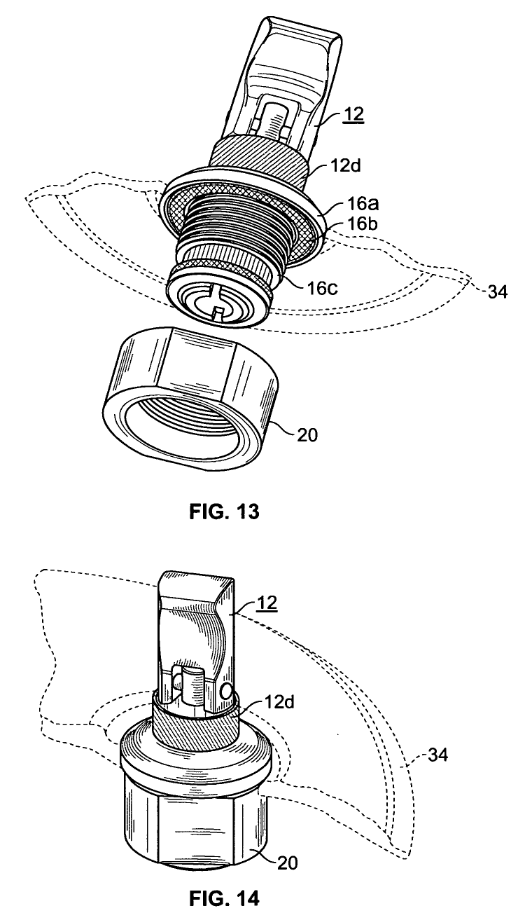

Referring to FIG. 10, when the pressure cooker 30 with the sleeve-suspended and color-coded safety valve 10 of the present invention installed is used for pressure cooking, a user, at first, heats the pressure cooker 30 over a stove (not shown). At the beginning of heating, the air pressure within the pressure cooker 30 is the same as the normal atmospheric pressure. The valve device 12 at this stage is suspended by the valve device suspending sleeve 16 at the bottom of the color band 14 as there is not enough interior air pressure to lift the valve device 12 up and off the valve device suspending sleeve 16. Therefore, only the color band 14 of the valve cylinder casing 12d is visible, signaling to the user that it is still safe to remove the lid 34 of the pressure cooker 30 as there is no air pressure buildup within the pressure cooker 30. At the beginning of heating and a short while thereafter, the gap 24 between the inner wall of the valve device suspending sleeve 16 and the valve cylinder casing 12d and the gap between the top of the valve device suspending sleeve 16 and the bottom of the color band 14 allow a small degree of air movement to the outside of the pressure cooker 30.

Referring to FIG. 11, as heating continues the moisture in the contents of the pressure cooker 30 turns into steam. As steam builds up, the moisture starts to condense around the bottom of the interior portion of the valve device 12. The gap 24 between the inner wall of the valve device suspending sleeve 16 and the valve cylinder casing 12d is small enough to induce “water seal” effect by capillary phenomenon. When enough moisture condenses around the bottom of the valve device 12, “water seal” effect kicks in and seals and gap 24, shutting down any air movement to the outside of the pressure cooker 30 through gap 24. This creates an airtight environment within the pressure cooker 30 and allows the air pressure within the pressure cooker 30 to build up faster than before. When the air pressure working on the bottom of the valve device 12 becomes greater than the gravity force working on the valve device 12 (weight of the valve device), the valve device 12 starts to rise within the valve device suspending sleeve 16. As the valve device 12 rises higher, the colored surface of the valve cylinder casing 12d becomes visible, warning the user that it is no longer safe to remove the lid 34 of the pressure cooker 30. When the valve device 12 rises up all the way, the washer 18 is pressed hard against the bottom of the threaded ring 16c of the valve device suspending sleeve 16, creating high degree of airtightness required for pressure cooking. In FIG. 11, the interior air pressure in still within the safe range, and the air aperture 12g is closed by the valve cylinder 12b.

In FIG. 12, the interior air pressure is abnormally high and the valve cylinder 12b is pushed upward past the air aperture 12g by the interior air pressure, opening up the air aperture 12g. The excess air pressure is released to the outside of the pressure cooker 30 through the air aperture 12g.

When heating is done, the user turns off heat or removes the pressure cooker 30 from the stove. Many recipes require to let cooking continue by the contents own heat to ensure thorough cooking and better-tasting food. When this process is over, the user is required to manually release the interior air pressure before the lid 34 is removed from the pressure cooker 30. Here, the sleeve-suspended and color-coded safety valve 10 is showing its warning sign (red or other stimulating color of the valve cylinder 12d), warning the user to proceed with caution even though the stove is off or the pressure cooker 30 is rather innocently sitting on a kitchen counter top. The user cautiously turns the release lever 12a of the valve device 12 down to the horizontal position and releases the interior air pressure.

With a pressure cooker with conventional safety valve, the user is required to listen to the hissing sound the escaping hot air creates and wait until the sound stops. This hissing sound may be quite loud at first, but it becomes less audible as the pressure goes down especially in a noisy kitchen. This may create a very dangerous situation as the source of the hissing sound is the very place where hot air is being released. In order to hear better, a user may put his or her ear dangerously close to the air aperture where very hot air may be still being released.

With the sleeve-suspended and color-coded safety valve 10, however, the user is warned by the easily recognizable red (or other stimulating color) warning sign while the air pressure is still high, or given a go-ahead by the green (or other soothing color) safety sign.

The sleeve-suspended and color-coded safety valve 10 of the present invention also addresses to the dangers associated with re-buildup of the air pressure within the pressure cooker 30 after a manual release of the interior pressure.

More specifically, one possible cause of pressure buildup after a manual release is inadequate air flow to the outside of the pressure cooker 30 through the air way (not shown) and the air aperture 12g of the valve device 12 at a relatively low level of interior air pressure. Since the sleeve-suspended and color-coded safety valve 10 is suspended by the valve device suspending sleeve 16 and the contact between the bottom side of the color band 14 of the valve cylinder casing 12d and the top of the valve suspending sleeve is not completely airtight, it provides a second air passage to the outside of the pressure cooker 30 at low levels of interior air pressure. Even with this feature, for some reason, if the interior air pressure rebuilds past safe level, the warning sign pos up and warns the user it is not safe to open the lid 34 of the pressure cooker. The other possible cause lies in carelessness of user. A user may inadvertently return the manual release lever 12a of the valve device 12 after an initial manual release of the interior air pressure. This may allow a dangerous buildup of interior air pressure. In this case, in the present invention, the waning sign readily pops up (red or other color becomes visible) and warned the user of the existence of high air pressure within the pressure cooker 30. Recognizing the warning/safety sign visually is far easier than distinguishing the position of the manual release lever.

As described above, the sleeve-suspended and color-coded safety valve of the present invention ensures safe operation of pressure cookers at every stage of pressure cooking, especially at the stages where users often relax and become less cautious.

1. A safety valve of a pressure cooker, comprised of a conventional safety valve structure, a raised band around the top portion of the casing of said conventional safety valve, a lip around the bottom of said casing of said conventional safety valve, and a sleeve into which said safety valve is inserted, where said safety valve is suspended within said sleeve at the bottom of said raised band and is free to move within and through said sleeve as much as the distance allowed by the bottom of said raised band and the top of said lip, which are formed larger than the inner diameter of said sleeve.

2. A pressure cooker comprised of a pot, a fitted lid and a safety valve according to claim 1, which is installed onto said lid in the way so that its upper portion is located outside of said lid and its lower portion is located inside of said lid.

3. The pressure cooker according to claim 2 where said raised band is in one color and said casing is in another.

4. A safety valve for a pressure cooker, comprising:
a valve device including a valve cylinder casing that is in one color;
a valve device suspending sleeve in which said valve device is provided so that said valve device is movable within said valve device suspending sleeve in an axial direction of said valve device;
a colored band member provided on an upper portion of said valve cylinder casing of said valve device, said colored band member supporting said valve device on said valve device suspending sleeve and being in another color; and
a sleeve securing means engageable to said valve device suspending sleeve, thus securing said valve device suspending sleeve to a lid of a pressure cooker.

5. The safety valve according to claim 4, further comprising a washer disposed on a lip of said valve cylinder casing, said lip being formed at a lower end of said valve cylinder casing.

6. The safety valve according to claim 4, further comprising a sealing ring provided under said top ring of said valve device suspending sleeve.

7. The safety valve according to claim 4, wherein said one color is indicative of danger and said another color is indicative of safety.

8. The safety valve according to claim 4, wherein said valve device suspending sleeve is comprised of a top ring and a thread ring formed integrally under said top ring, and sleeve securing means is screwed to said thread ring.

9. A pressure cooker comprising:
a pot;
a lid fitted on and closing an opening of said pot; and
a safety valve provided on said lid and comprised of:
a valve device including a valve cylinder casing that is in one color,
a valve device suspending sleeve in which said valve device is provided so as to be movable within said valve device suspending sleeve in an axial direction of said valve device,
a band member provided on an upper portion of said valve cylinder casing of said valve device so that said band member supports said valve device on said valve device suspending sleeve, said band member being in another color, and
a sleeve securing means engaged to said valve device suspending sleeve to secure said valve device suspending sleeve to said lid.

10. The safety valve according to claim 9, wherein said one color is indicative of danger, and said another color is indicative of safety.
